(19) United States
(12) Patent Application Publication
(10) Pub. No.: US 2023/0269548 A1
(43) Pub. Date: Aug. 24, 2023

(54) METHOD FOR OPERATING A BINAURAL HEARING DEVICE SYSTEM AND BINAURAL HEARING DEVICE SYSTEM

(71) Applicant: Sivantos Pte. Ltd., Singapore (SG)

(72) Inventor: Cecil Wilson, Erlangen (DE)

(21) Appl. No.: 18/169,564

(22) Filed: Feb. 15, 2023

(30) Foreign Application Priority Data
Feb. 18, 2022 (DE) 10 2022 201 706.4

(51) Int. Cl. H04R 25/00

(52) U.S. Cl. CPC H04R 25/552; H04R 25/505; H04R 25/604; H04R 25/405; H04R 25/407; H04R 2225/41

(57) ABSTRACT

A method for operating a binaural hearing device system having hearing devices assigned or to be assigned to left and right ears of a user and having microphones, includes capturing items of acoustic information using the hearing devices. The acoustic information items are evaluated for whether they contain music. It is ascertained whether two sources are detectable for the music. A spatial angle range, in which the respective source of the music is positioned, is ascertained with respect to a user viewing direction. If the respective spatial angle range of the two sources of the music is in a front half space relative to the viewing direction, a probability is increased that a situation of intentionally listening to music by the user is present. If a specified probability limiting value is exceeded, signal processing for the hearing devices is adapted with respect to the most natural possible music reproduction.

### CROSS-REFERENCE TO RELATED APPLICATION

This application claims the priority, under 35 U.S.C. § 119, of German Patent Application DE 10 2022 201 706.4, filed Feb. 18, 2022; the prior application is herewith incorporated by reference in its entirety.

### FIELD AND BACKGROUND OF THE INVENTION

The invention relates to a method for operating a binaural hearing device system. In addition, the invention relates to such a binaural hearing device system.

Hearing devices are typically used to output a sound signal to the sense of hearing of the wearer of the hearing device. The output takes place in that case by using an output transducer, usually acoustically through airborne sound by a loudspeaker (also referred to as a “receiver”). Such hearing devices are often used as so-called hearing aid devices (also hearing aids for short). For that purpose, the hearing devices normally include an acoustic input transducer (in particular a microphone) and a signal processor, which is configured to process the input signal (also: a microphone signal) generated by the input transducer from the ambient sound with application of at least one signal processing algorithm, typically stored specifically for a user, in such a way that a hearing loss of the wearer of the hearing device is at least partially compensated for. In particular in the case of a hearing aid device, the output transducer, in addition to a loudspeaker, can also alternatively be a so-called bone vibrator or a cochlear implant, which are configured for mechanically or electrically coupling the sound signal into the sense of hearing of the wearer. The term hearing devices in particular also includes devices such as so-called tinnitus maskers, headsets, headphones, and the like.

Typical structural forms of hearing devices, in particular hearing aids, are behind-the-ear (“BTE”) and in-the-ear (“ITE”) hearing devices. These designations are directed to the intended wearing position. Thus, behind-the-ear hearing devices have a (main) housing, which is worn behind the pinna. It is possible to distinguish in that case between models, the loudspeaker of which is disposed in that housing. The sound output to the ear typically takes place by using a sound tube, which is worn in the auditory canal, and models which have an external loudspeaker, which is placed in the auditory canal. In-the-ear hearing devices, in contrast, have a housing which is worn in the pinna or even completely in the auditory canal.

Depending on the hearing loss, a monaural or a binaural treatment can also come into consideration. The former is regularly the case if only one ear has a hearing loss. The latter is usually the case when both ears have a hearing loss. In the case of a binaural treatment, a data exchange takes place between the two hearing devices associated with the ears of the user, in order to have more items of acoustic information available and thus make the hearing experience for the user even more pleasant, preferably more realistic.

In addition, a so-called classifier is often used, which is to recognize specific hearing situations—for example a conversation in peace, a conversation with interference noise, music, quiet, car driving, and the like—usually by using pattern recognition, artificial intelligence, and the like. The signal processing can be adapted on the basis of these hearing situations to improve the hearing experience of the respective hearing situation. Thus, for example, in the case of conversations having interference noises, a comparatively narrow directional effect can be specified and noise suppression can be used. However, this is less expedient for music, since in that case the broadest possible directional effect or omni-directionality and also low or deactivated noise suppression are advantageous, in order to “lose” as little “acoustic information” as possible.

In particular in the case of music, however, a misinterpretation of the classifier—namely when music is present, but the user is not listening to it or does not wish to listen to it at all—in which the setting to improve hearing the music can have negative effects on the speech comprehension and the like.

While in the case of classic hearing aids so-called “hearing programs” were discussed, which have comparatively fixedly specified parameter sets, in modern hearing aids, a step-by-step adjustment of the individual parameters is usually applied to enable intermediate steps between two hearing situations, a soft cross-fade between various settings, or the like.

### SUMMARY OF THE INVENTION

It is accordingly an object of the invention to provide a method for operating a binaural hearing device system and a binaural hearing device system, which overcome the hereinafore-mentioned disadvantages of the heretofore-known methods and systems of this general type and which further improve the usage comfort of a hearing device system.

This object is achieved according to the invention by a method and a hearing device system having the steps and the features described below. Advantageous embodiments and refinements of the invention, which are partially inventive as such, are represented in the dependent claims and the following description.

With the foregoing and other objects in view there is provided, in accordance with the invention, a method for operating a binaural hearing device system. The system has a hearing device assigned or to be assigned to a left ear and one assigned or to be assigned to a right ear of a user (in the intended operation). Each of the hearing devices in turn has at least one microphone in each case. In the scope of the method (i.e., in particular in the intended operation), items of acoustic information are captured by using the two hearing devices and the items of acoustic information (in particular in the form of ambient noises, preferably in the form of electronic signals representing the ambient noises) are evaluated as to whether they contain music. In addition, it is ascertained whether two (in particular spatially separated) sources can be detected for the music (i.e., when the presence of music is recognized). Furthermore, a spatial angle range is ascertained with respect to a viewing direction of the user, in which the respective source of the music is positioned. For the case that the respective spatial angle range of the two sources of the music is in a front half space with respect to the viewing direction, a probability (in particular a probability value) is increased that a situation of intentionally listening to music by the user exists, and if a predefined probability limiting value is exceeded (thus for the case of intentionally listening to music), signal processing for both hearing devices is adapted with respect to the most natural possible reproduction of the music.

The “viewing direction” of the user designates in this case and hereinafter in particular the direction in which the head of the user is directed, independently of the actual viewing direction of the eye. With respect to the medical understanding of the body directions, the “viewing direction” thus in particular designates hereinafter a (head) direction also designated by “rostral” (possibly also with “nasal”). This designation is based on the two hearing devices of the binaural hearing device system being worn approximately symmetrically on the head in intended operation (in the scope of the anatomical possibilities), wherein the viewing direction typically corresponds to a direction used for the signal processing as the 0° direction of the hearing device system.

“Spatial angle range” is understood in this case and hereinafter in particular as a comparatively small angle range, preferably open like a cone and originating from the face of the user and/or the respective hearing device. As a “range” this takes into consideration the circumstance that a spatial localization of a source is regularly connected to comparatively high tolerances, so that an exact position specification is usually not possible. The term “spatial angle range” nonetheless also covers a vector which points toward the located source.

The “front half space” designated above is understood in this case and hereinafter in particular as the space which is spanned rostrally by a frontal plane of the head, which is preferably positioned at the ears of the user. The front half space is therefore the one which the user “looks into.”

Adaptation of the signal processing is understood in this case and hereinafter in particular as a change of parameters which influence the reproduction of acquired tone signals (in particular the microphone signals representing them, which are captured by the respective microphone, or signals derived therefrom). These parameters are, for example, (in particular frequency-dependent) amplification factors, settings for so-called compression, settings of filters (which are used, for example, for noise suppression), and the like.

In particular from the information that two sources are “located” in the front half space for the music, it is thus recognized, the conclusion is drawn, or at least a probability for it is increased that a stereo representation of the music is provided and the user, since the “music sources” are located in the front half space, is facing toward the stereo sources and therefore is intentionally listening to the music. The classification result that music is present can therefore advantageously be “refined” in such a way that the user also intentionally listens to the music (at least with a sufficiently high probability). An adaptation of the signal processing for better reproduction of the music is therefore less susceptible to error under these presumptions, thus more reliable in comparison to the mere recognition that music is present in the ambient noises. In particular, a risk that the signal processing incorrectly changes to a music setting, although the user is not intentionally listening to the music at all, can thus be reduced. In addition, the possibility is provided in this way of adapting the signal processing comparatively strongly (or also differently strongly or “aggressively” depending on the situation) for the reproduction of music. This has heretofore been avoided due to the previously possible misinterpretations in order, for example, not to restrict a speech comprehension of the user too much, if a situation of intentionally listening to music is not present in spite of the classification music. The above-described “locating” of the music sources in the front half space therefore represents a criterion to increase the probability for intentionally listening to music and if necessary adapting the signal processing for better reproduction of music.

The probability limiting value is optionally specified in such a way that the arrangement of the music sources in the front half space is already sufficient to exceed the probability limiting value.

In one expedient method variant it is ascertained (preferably additionally) whether the acoustic signals originating from the two music sources are dissimilar to one another within a framework typical for music, in particular for a stereo presentation of the music, i.e., in particular within specified limits. A stereo presentation of a piece of music thus generally contains signal components comparatively similar to one another on both stereo channels, but which are also in turn comparatively dissimilar to give the stereo impression. If such a difference between the two music sources is detected, in this optional method variant a particularly high probability is assumed for the presence of a real stereo presentation and in particular also for intentionally listening to this stereo presentation (in other words the above-described probability value is further increased). In this case, the signal processing, in comparison to the mere presence of two music sources in the front half space, can be adapted “more aggressively”, i.e., with comparatively stronger negative effects on speech comprehension or the like, to the (most natural possible) reproduction of music. In an optional refinement, the signal processing is only adapted for better reproduction (thus the most natural possible) of the music when a situation having a real stereo presentation is concluded as above. This ascertainment as to whether a real stereo presentation is present therefore preferably represents a refined criterion for adapting the signal processing.

For example, for the above-described detection of the real stereo presentation, a correlation (in particular a so-called “stereo correlation coefficient”), which is preferably frequency dependent (i.e., in particular carried out separately on different frequency bands), is ascertained between the acoustic signals assigned to the two music sources. For this stereo correlation coefficient (in particular the respective frequency-dependent one), limits are preferably specified, within which this stereo correlation coefficient has to be in order to conclude a dissimilarity typical for stereo.

The above-mentioned limits (in particular the upper and lower limits) for the stereo correlation coefficient (in particular the respective, frequency-dependent one) are preferably selected in such a way that they are below values which are typical for a mono presentation, and above those for uncorrelated (or only slightly correlated) noises. On the one hand, a mono presentation could theoretically be assumed at 100%, however, in a typical hearing environment due to, for example, tolerances of the microphones used, ambient sounds, etc., lower values of the correlation coefficient are regularly reached for a mono presentation (for example “only” 90%). On the other hand, correlation values of completely uncorrelated signals are also typically above “zero” percent, since this value is only to be assumed for white noise, but ambient sounds (and thus also music from only one music source or “mono music” from multiple music sources) are regularly recorded similarly by microphones used alone. For example, the above-mentioned limits are therefore specified so that they bound a range between 40 and 90%, furthermore, for example, between 50 and 80 or even only 70% (the latter to enable a sufficient distance to a mono presentation).

In one expedient method variant (in particular in the context of a further refined additional or also alternative criterion for detection of the real stereo presentation), the situation of intentionally listening to music of the user is concluded (or at least the probability that such a situation is present is increased further) if the respective spatial angle range of the music sources is in an angle range up to approximately +/−60°, preferably up to approximately +/−45°, in relation to the viewing direction. Such a situation suggests with comparatively high probability intentionally listening to a stereo presentation, since in particular in private spaces the stereo loudspeakers are usually located in such an angle range with respect to the position of the listener due to the delimited space boundary. A listener will typically also have directed his viewing direction, at least the assigned sagittal plane (or in particular the medial plane) at least roughly between the stereo loudspeakers when intentionally listening in stereo.

In a further expedient method variant, each hearing device has two microphones in each case. In this case, the respective spatial angle range of the two music sources is ascertained in particular on the basis of a time delay of a signal assigned to the music expediently between the two microphones of a hearing device. For this purpose, in particular a “direction of arrival” or “direction of incidence” (“direction of arrival”) is determined. Reference is made for this purpose, for example, to International Publication WO 2019 086 435 A1 and International Publication WO 2019 086 439 A1, the content of which is hereby incorporated by reference in its entirety.

For example, the recognition or detection of the music sources described at the outset takes place by using a so-called (in particular “blind”) source separation. The recognition of the music sources, in particular the two “stereo sources” optionally takes place in this case before the ascertainment of the assigned spatial angle range. Alternatively, however, the spatial angle range can also be determined first, in which a signal source is located and it is only then ascertained whether this signal source represents a music source. In the latter case, for example, different sound sources (in particular separable from one another) are thus assigned a spatial angle range. The above-described source separation, for example on the basis of frequency bands, to which a source type (for example, music, speech, natural noise) is assigned optionally also takes place in parallel in this case. In a downstream step, the items of information about the localization of the individual sources and about the source type are then combined. For the case that the sources are located on the basis of an elevated level in a specific segment, for example, the source type can be assigned in that it is ascertained whether the frequencies of the source assigned to this level value sufficiently correspond to the frequencies recognized for music, or also whether the level value acquired for the music frequency band corresponds sufficiently to the level value assigned to the source. If the levels and/or frequencies correspond, a probability value is increased that the ascertained source type is to be assigned to this specific source (and therefore also to that for this ascertained spatial angle range). If the probability value is sufficiently high (for example on the basis of a threshold value comparison), the located source is assigned the source type (thus in particular the source type “music”).

In an alternative, optional, but also additional method variant, in which each hearing device preferably also has two microphones, the respective spatial angle range of the two sources is ascertained by using a type of scanning by directional sensitivity, which is formed in particular by using two microphones of a hearing device. The directional sensitivity is optionally formed by a binaural combination of both hearing devices. In the latter case, this is also referred to as binaural directional microphonics. In this case, each hearing device can in principle also have only one microphone. In the present method variant, the front half space is preferably scanned. In particular, in the present case the space around the head of the user of the hearing device, preferably the front half space, is divided into sectors. A type of directional lobe or a “sensitivity range” of the directional microphone formed is directed into each of these sectors. The acoustic intensities (also “levels”) acquired for the respective sectors are compared to one another and intensity or level values increased in relation to other sectors are used as an indicator that a signal source is disposed in this sector. By interpolation between two sectors, a signal source disposed at the sector edge or between two sectors can also be acquired in this case, specifically this can be assigned a spatial angle range in which it is disposed.

In a further expedient method variant, only sources having a comparatively directed emission characteristic—as is the case, for example, with loudspeakers—are recognized. For example, only emission angles of approximately 90° are recognized for a source.

Additionally or alternatively, only sources up to a specified distance to the user, for example up to 8 or also only up to 5 m, are recognized as (music) sources.

In a further expedient method variant—as also already discussed in the above method variant—binaural processing and evaluation is carried out of the items of information acquired by using both hearing devices with respect to the presence of the music and the spatial angle range of the respective source. In particular, a data exchange thus takes place between the two hearing devices. In the scope of such binaural signal processing, in particular the items of acoustic information of both hearing devices are further processed together, in order, for example, in the context of binaural directional microphonics, to increase the spatial information content and possibly to approximate the sound experience even closer to the real hearing situation and/or (in particular using the increased information content), to improve the speech comprehension, noise suppression, and the like. In the context of the evaluation—in particular also using the increased information content—the situation classification (thus in particular whether music is present at all) and also the recognition and location of individual music sources are carried out in this case.

In one advantageous method variant, it is monitored that the two music sources (i.e., in particular the stereo sources for the music) only move relative to one another within a specified, permissible (spatial) angle range. In particular, the two music sources are each “tracked”. That is to say, a change of the position of the respective source, in particular its spatial angle range, in which it was located, is acquired and “tracked” (for example in that a directional effect is oriented thereon). A movement of the sources relative to the viewing direction can occur, for example, if the user of the hearing device turns his head and/or changes his (body) position in space relative to the music sources. If the music sources are loudspeaker boxes, the two music sources remain constant in relation to one another or only move within a comparatively narrow spatial angle range. In the case of solely turning the head, it is to be assumed in this case that an angle between the two vectors (originating from the user) pointing toward the two music sources remains constant. If the user, for example, bends forward from an armchair, for example, in order to drink something, to eat, or the like, the angle between the two vectors will change, but typically only comparatively slightly (for example by at most 20°). If the two music sources remain within this permissible angle range (for example up to 10 or up to 20°), the presence of the situation of intentionally listening to music is still present. If a greater movement of the music sources in relation to one another takes place, for example because the user of the hearing devices gives up his position in the space, or even leaves the space entirely, in contrast, it is presumed that the situation of intentionally listening to music is no longer present and in particular the signal processing is reset to the preceding settings or a new classification of the hearing situation is performed. Optionally in this case, in particular as long as the two music sources are still present (for example because the user has only moved into another area of the space), a waiting time is started and waited out as to whether the user changes back into his preceding position relative to the two music sources. This can be expedient, for example, if the user only briefly moves away in the same space, for example only gets something (for example to drink), but fundamentally still wishes to listen to the music.

In a further advantageous method variant, the presence of the situation of intentionally listening to music is excluded if a movement is only recognized for one of the two music sources. In particular, such a movement is acquired as described above. Since only one source moves, it can be recognized in particular thereon that for the other source, the spatial angle range which was detected for it remains constant, but changes for the “first” source. Such a case is in particular not to be reconciled with a stereo presentation and rather indicates a different situation, for example two music sources independent of one another and possibly different.

In a further expedient method variant, spectral differences between the music acquired by using the respective hearing device and/or for the respective source are ascertained. A type of music is subsequently concluded on the basis of these differences. For classical music, in particular orchestral music, due to a classical orchestra structure typically to be used, a comparatively large spectral difference of the two stereo channels and thus of the sound emitted from the two (stereo) music sources is generally to be expected. A rather larger spectral difference is also to be expected comparatively for recordings of jazz bands. For pop, rock music, or electronic music, in contrast, a comparatively lesser spectral difference is to be expected. In order to further distinguish the respective subtypes of the music, for example as pop and rock music, a further spectral evaluation (for example with respect to an “emphasis” of certain frequencies) and/or also a harmonic evaluation can take place. This embodiment is based on the knowledge that each hearing device predominantly acquires the acoustic signals from the assigned front quarter space, i.e., in particular at a stronger level. In contrast, the acoustic signals from the other quarter space (thus those assigned to the other half of the face) are usually not acquired or are only acquired in an attenuated manner due to shading effects.

The signal processing is preferably subsequently, in particular in a further refined manner, adapted to the music type. Thus, for example, the parameters discussed above are adapted in a manner known per se (cf., for example equalizer presets in audio systems) to the type of music. For example, in the case of classical, the “highs”, thus high frequencies are accentuated (“emphasized”) in relation to the other frequencies, in the case of jazz the most balanced possible setting is selected, while in the case of hip-hop or pop, for example basses are emphasized.

In one expedient method variant, the signal processing is adapted in a sliding manner to the reproduction of music for cases in which several of the above-described criteria are observed, thus, for example, whether in addition to the arrangement of the music sources in the front half space, they are in a smaller spatial angle range than 180° and/or whether a real stereo presentation is present. In other words, the signal processing becomes less “aggressive”, i.e., changed to negatively influence other aspects of the hearing (in particular the speech comprehension) comparatively little if the two music sources are only located in the front half space. With further increasing probability (i.e., cumulative fulfillment of multiple criteria) for the situation of intentionally listening to music, for example if the spatial angle range is reduced in size, the signal processing is adapted increasingly more aggressively in the direction of music reproduction, for example in that a noise suppression and/or a directional effect is reduced and the like.

The binaural hearing device system according to the invention has, as described above, the hearing devices assigned or to be assigned to the left ear and the right ear of the user. These each have at least one microphone. In addition, the hearing device system has a controller which is configured to carry out the above-described method automatically or in interaction with the user.

The hearing device system therefore has the physical features described above in the respective method variants similarly in corresponding embodiments. The controller is also accordingly configured to carry out the measures described in the context of the above method variants in associated embodiments.

The controller is, for example, embodied in one of the two hearing devices or a control unit assigned to them, but separate therefrom. In particular, however, each of the two hearing devices has a separate controller (also referred to as a signal processor), which are in communication with one another in binaural operation and preferably jointly form the controller of the hearing device system in this case under a master-slave regulation with one another.

In one preferred embodiment, the (or the respective) controller is formed at least in the core by a microcontroller having a processor and a data memory, in which the functionality for carrying out the method according to the invention is implemented by programming in the form of operating software (firmware), so that the method—possibly in interaction with the user—is carried out automatically upon execution of the operating software in the microcontroller. Alternatively, the or the respective controller is formed by an electronic component which is not or is not completely freely programmable, for example an ASIC, in which the functionality for carrying out the method according to the invention is implemented using circuitry measures.

The above-described hearing device system and also the above-described method advantageously also function in the case of sound systems having more than two sound sources, for example a 5.1 system or the like. As described above, the presence of two music sources in the front half space is used as a fundamental criterion as to whether a situation of intentionally listening to music exists. If more than these two music sources are present, in particular in the rear half space, these are, for example, not acquired or are left unconsidered as irrelevant for the assessment of the current (music) hearing situation.

The conjunction “and/or” is to be understood in this case and hereinafter in particular to mean that the features linked by using this conjunction can be formed both jointly and also as alternatives to one another.

Other features which are considered as characteristic for the invention are set forth in the appended claims.

Although the invention is illustrated and described herein as embodied in a method for operating a binaural hearing device system and a binaural hearing device system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, plan view of a binaural hearing device system;

FIG. 2 is a top plan view of a head of a user of the hearing device having the hearing device system in operation;

FIG. 3 is a view similar to FIG. 2 of the hearing device system in an alternative exemplary embodiment of the operation; and

FIG. 4 is a block diagram of both hearing devices illustrating the operating method carried out thereby.

### DETAILED DESCRIPTION OF THE INVENTION

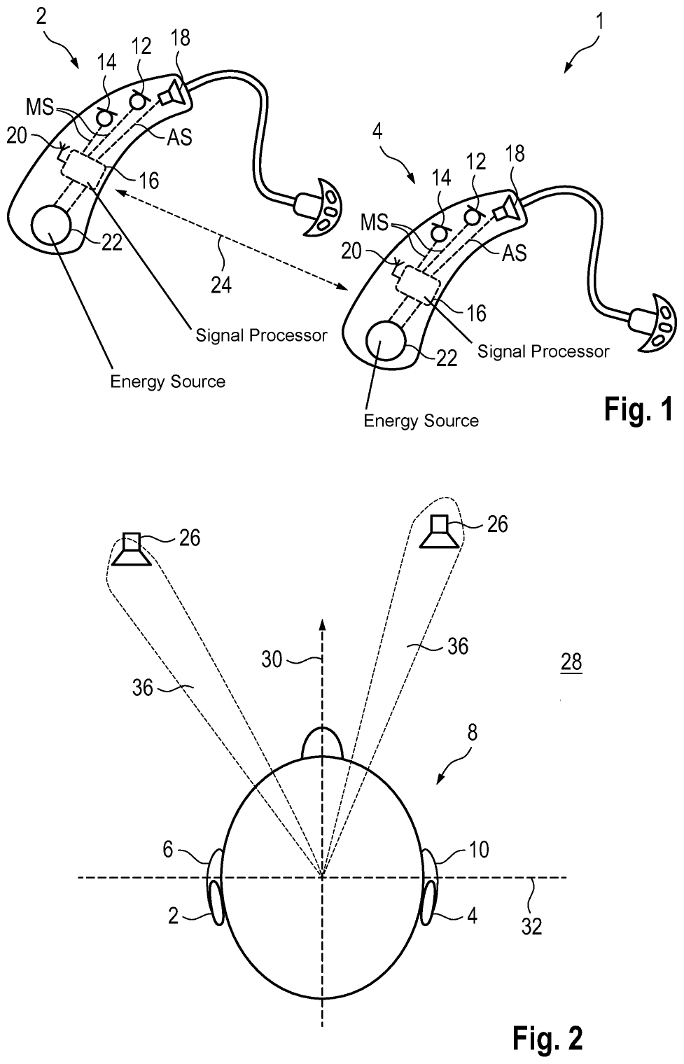

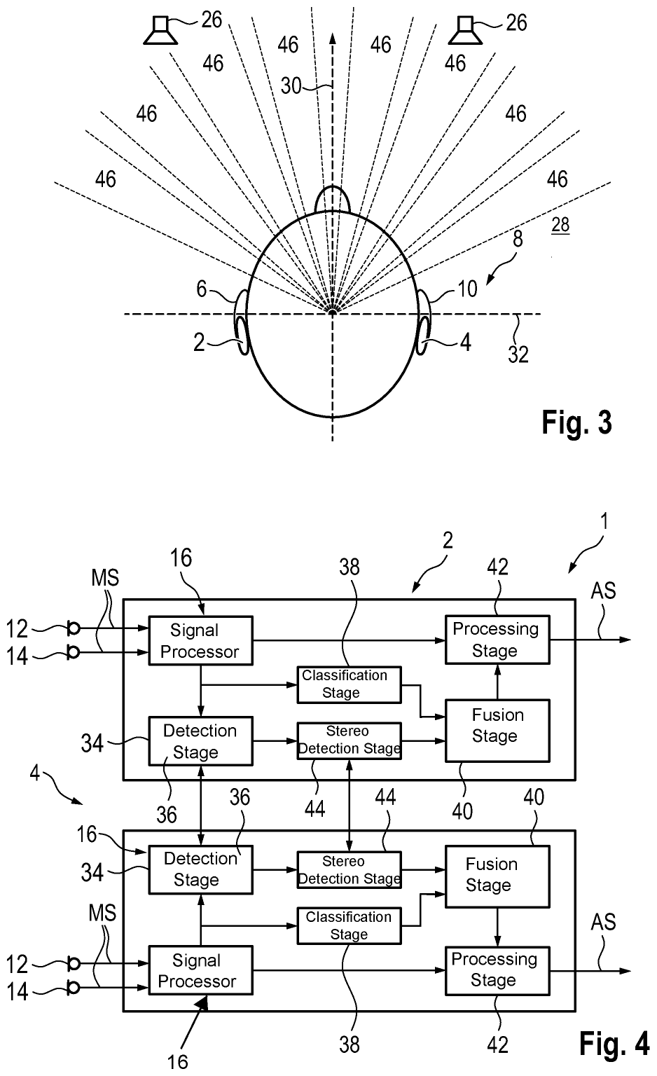

Referring now in detail to the figures of the drawings, in which parts and variables corresponding to one another are always provided with identical reference signs, and first, particularly, to FIG. 1 thereof, there is seen a diagrammatically-illustrated binaural hearing device system 1. The system has two hearing devices 2 and 4. The hearing device 2 is assigned in intended operation—diagrammatically shown in FIG. 2 or 3—to a left ear 6 of a user 8. The hearing device 4 is accordingly assigned to the right ear 10 of the user 8. Each hearing device 2, 4 has a front microphone 12 and a rear microphone 14. In addition, both hearing devices 2 and 4 have a signal processor 16, a loudspeaker 18, a communication unit 20, and an energy source 22.

The signal processor 16 is configured to process ambient sound, which was acquired by using the microphones 12 and 14 and converted into microphone signals MS, in dependence on a hearing loss of the user 8, specifically to filter and amplify it depending on frequency, and to output it as an output signal AS at the loudspeaker 18. The latter in turn converts the output signal AS into sound to be output for the sense of hearing of the user 8.

In a binaural operation of the hearing device system 1, the two hearing devices 2 and 4 are in communication with one another. Specifically, both signal processors 16 transmit data with one another (indicated by a double arrow 24) by using the respective communication units 20. One of the signal processors 16 forms a “master” in this case, the other a “slave.” The two signal processors 16 thus also jointly form a controller of the hearing device system 1. The controller (usually the signal processor 16 functioning as the master) processes, among other things, the microphone signals MS of both hearing devices 2 and 4 to form a binaural directional microphone signal. Furthermore, the controller is configured to classify different hearing situations on the basis of the items of information contained in the microphone signals MS and to change the signal processing of the microphone signals MS in dependence on the classification, i.e., to adapt signal processing parameters. In addition, the signal processors 16, specifically the controller, are configured to carry out an operating method described in more detail hereinafter.

The controller ascertains whether music is contained in the ambient noises. However, to avoid the signal processing incorrectly being set to music, although music is only coincidentally contained in the ambient noises, the controller ascertains whether multiple sound sources for the music, indicated in this case by two loudspeaker boxes 26, are present in the surroundings of the user 8. Specifically, the controller ascertains whether the two loudspeaker boxes 26 are located in a front half space 28. The front half space 28 represents in this case the spatial area lying in a viewing direction 30 (see FIG. 2) in front of a frontal plane 32 intersecting the two ears 6 and 10.

According to an exemplary embodiment described on the basis of FIGS. 2 and 4, both signal processors 16 use a “detection stage 34” (see FIG. 4) for this purpose, which ascertains a so-called direction of arrival for the sound originating from the two loudspeaker boxes 26 in a known manner by using the two microphones 12 and 14. The respective direction of arrival is used in this case (in particular in the form of a vector) as a spatial angle range 36 (in relation to the viewing direction 30 as the zero degree direction), in which the respective loudspeaker box 26 is disposed. A classification of the current hearing situation takes place in parallel in a classification stage 38. It is ascertained in this case whether music is present. If this is the case and two different sound sources, thus each disposed in one spatial angle range 36, are acquired, it is checked in a fusion stage 40, in which the items of information of the classification stage 38 and the detection stage 34 are combined, whether both sound sources output the same music. If a sound source for the music recognized in the classification stage 38 is thus ascertained for each of the two hearing devices 2 and 4 within a spatial angle range 36 disposed in the front half space 28—which is established on the basis of the communication of both hearing devices 2 and 4 with one another (cf. FIG. 4)— the controller assumes in the fusion stage 40 that a situation having a stereo presentation of the music exists. The controller takes this as an indication to increase a probability value that a situation of intentionally listening to music is present. At sufficiently high probability (which is the case if it is only checked that the two sound sources are disposed in the front half space 28), the controller adapts parameters for the signal processing of music for a downstream processing stage 42. For example, the controller sets a so-called compression linearly and reduces a noise suppression.

In an optional variant, a stereo detection stage 44 is connected upstream from the fusion stage 40, in which it is ascertained whether both sound sources output sufficiently similar but not exactly the same sound signals, the latter is the case with a stereo presentation by using a stereo system having two loudspeaker boxes 26, if the output is not set to “mono.” In this variant, the probability value is increased further in relation to the above-described variant if such a stereo presentation is recognized. In this case, the probability value first reaches a limiting value, from which the parameters are changed for the signal processing of music, with this “additional” increase.

Additionally or alternatively, in an optional further variant the probability value is also increased if the two sound sources are not only in the front half space 28, but also in a narrow spatial range of 60° on both sides of the viewing direction 30.

Furthermore, the controller optionally does not switch over the signal processing between two parameter sets upon reaching the probability limiting value, but increasingly changes the parameters with increasing probability, so that a situation-dependent increasing change of the signal processing is implemented.

An alternative exemplary embodiment is shown in FIG. 3. Instead of the acquisition of the direction of arrival, a directional sensitivity of a binaural directional microphone is set in the detection stage 34 in such a way that multiple sectors 46 having sensitivity increased in relation to the other spatial areas are distributed like a fan in the front half space 28. A level value is acquired for each sector 46 and compared to those of the other sectors 46. An increased level value indicates a sound source in the area of the sector 46. For more precise locating, an interpolation is performed between the sectors 46 in an optional variant, so that a sound source disposed between two sectors 46 (indicated in FIG. 3 by the loudspeaker box 26 shown on the left) can be detected, more precisely its spatial angle range 36 can be bounded more narrowly.

The further procedure again corresponds to the preceding exemplary embodiments and possibly its variants.

The decision as to whether two sound sources are present for the music and the measures resulting therefrom, thus in particular the decision about the change of the signal processing parameters, is made in one variant of the above-described exemplary embodiments by the signal processor 16 functioning as the master and transmitted to the signal processor 16 functioning as the slave.

On the basis of the above-described procedure, the signal processing is first changed by the controller when two sound sources are recognized for the music, thus the two loudspeaker boxes 26 in this case. A misinterpretation and adaptation of the signal processing for music for cases in which, for example, only one sound source is present, for example in the case of an advertising speaker in a pedestrian zone or the like, is thus effectively avoided.

The subject matter of the invention is not restricted to the above-described exemplary embodiments. Rather, further embodiments of the invention can be derived by a person skilled in the art from the above description. In particular, the individual features of the invention described on the basis of the various exemplary embodiments and their embodiment variants can also be combined with one another in another way.

The following is a summary list of reference numerals and the corresponding structure used in the above description of the invention.

### LIST OF REFERENCE SIGNS

1 hearing device system
2 hearing device
4 hearing device
6 ear
8 user
10 ear
12 microphone
14 microphone
16 signal processor
18 loudspeaker
20 communication unit
22 energy source
24 double arrow
26 loudspeaker box
28 half space
30 viewing direction
32 frontal plane
34 detection stage
36 spatial angle range
38 classification stage
40 fusion stage
42 processing stage
44 stereo detection stage
46 sector
AS output signal
MS microphone signal

1. A method for operating a binaural hearing device system, the method comprising:
providing a hearing device assigned or to be assigned to a left ear and a hearing device assigned or to be assigned to a right ear of a user, each respective hearing device having at least one microphone;
using both of the hearing devices to capture items of acoustic information;
evaluating the items of acoustic information as to whether the items of acoustic information contain music;
ascertaining whether two sources can be detected for the music;
ascertaining, with respect to a viewing direction of the user, a spatial angle range in which a respective source of the music is positioned; and
upon the respective spatial angle range of the two sources of the music being in a front half space with respect to the viewing direction, increasing a probability of a presence of a situation of intentionally listening to music by the user, and upon exceeding a specified probability limiting value, adapting signal processing for both of the hearing devices with respect to a most natural possible reproduction of the music.

2. The method according to claim 1, which further comprises ascertaining whether acoustic signals originating from the two sources are dissimilar to one another within a framework typical for music, and further increasing the probability that the situation of intentionally listening to music exists upon recognizing the dissimilarity.

3. The method according to claim 1, which further comprises further increasing the probability that the situation of intentionally listening to music is present upon the respective spatial angle range of the sources of the music being in an angle range up to approximately +/−60° in relation to the viewing direction.

4. The method according to claim 3, which further comprises setting the angle range to be up to approximately +/−45°.

5. The method according to claim 1, which further comprises providing each respective hearing device with two microphones, and ascertaining the respective spatial angle range of the two sources based on a time delay of a signal assigned to the music.

6. The method according to claim 1, which further comprises ascertaining the respective spatial angle range of the two sources by scanning using directional sensitivity.

7. The method according to claim 6, which further comprises carrying out the scanning at a front half space.

8. The method according to claim 1, which further comprises carrying out binaural processing and evaluation of the items of information acquired by using both hearing devices with respect to the presence of the music and the spatial angle range of the respective source.

9. The method according to claim 1, which further comprises monitoring whether the two sources only move within a specified permissible angle range relative to one another.

10. The method according to claim 1, which further comprises excluding the presence of the situation of intentionally listening to music upon recognizing a movement for only one of the two sources.

11. The method according to claim 1, which further comprises ascertaining spectral differences between the music acquired by at least one of using the respective hearing device or for the respective source, leading to a conclusion of a type of music.

12. The method according to claim 11, which further comprises adapting the signal processing to the type of music.

13. A binaural hearing device system, comprising:
a hearing device assigned or to be assigned to a left ear and a hearing device assigned or to be assigned to a right ear of a user;
each respective hearing device having at least one microphone and a controller configured to carry out the method according to claim 1.
